(19) United States
(12) Patent Application Publication
(10) Pub. No.: US 2022/0087320 A1
(43) Pub. Date: Mar. 24, 2022

(54) ELECTRONIC CIGARETTE AND ATOMIZING DEVICE THEREOF

(71) Applicant: O-NET AUTOMATION TECHNOLOGY (SHENZHEN) LIMITED, Shenzhen, Guangdong (CN)

(72) Inventors: Aimin Mao, Shenzhen, Guangdong (CN); Huihua Huang, Shenzhen, Guangdong (CN); Pengfei Zhang, Shenzhen, Guangdong (CN); Meiling Guo, Shenzhen, Guangdong (CN); Bo Zhou, Shenzhen, Guangdong (CN)

(21) Appl. No.: 17/420,805

(22) PCT Filed: Jan. 17, 2019
(86) PCT No.: PCT/CN2019/072216

§ 371 Date: Jul. 6, 2021

(51) Int. Cl. A24F 40/46; A24F 40/485; A24F 40/42; A24F 40/10; A24F 40/50; H05B 3/06

(52) U.S. Cl. CPC A24F 40/46; A24F 40/485; A24F 40/42; H05B 2203/021; A24F 40/50; H05B 3/06; H05B 2203/016; A24F 40/10

(57) ABSTRACT

An atomizing device, including a first housing, an air duct, an atomizing assembly, a heating assembly, a base and a first electrode assembly. A first end of the first housing is provided with an air outlet, and a second end of the first housing is open. The atomizing assembly is disposed in the second end, the base is disposed on the second end and connected with the atomizing assembly. The air duct is disposed in the first housing and two ends of the air duct are respectively connected with the air outlet and the atomizing assembly. The heating assembly is disposed on the atomizing assembly, and an atomizing chamber is defined between the heating assembly and the base. The air inlet, the atomizing chamber, the air duct and the air outlet are communicated The first electrode assembly is disposed on the base and in contact conduction with the heating assembly.

### TECHNICAL FIELD

The present disclosure relates to the technical field of electronic cigarettes, in particular to an electronic cigarette and an atomizing device thereof.

### BACKGROUND

An electronic cigarette is generally composed of an atomizing device and a power supply device. Conventionally, the atomizing device of the electronic cigarette includes components such as a screw thread, an electrode, a sealing member, an air duct, a heating assembly, a liquid storage cotton, a glass fiber tube, a plastic tube, and a suction nozzle. The number of the components is large, the structure is complex, the assembly is not easy and the cost is high. The heating assembly is mainly electrically connected by welding, which is prone to false welding, poor contact and other phenomena, so that the heating assembly can not work normally. The atomizing device formed by assembling a plurality of components has a relatively large integral volume and occupies a large space in the electronic cigarette, so that the electronic cigarette has a relatively large integral volume and is not convenient for a user to carry.

### SUMMARY

The technical problem to be solved by the present disclosure is to provide an atomizing device of an electronic cigarette, which is simple in structure and low in cost, and the electronic cigarette with the atomizing device.

The technical solution adopted by the present disclosure to solve the technical problem is to provide an atomizing device of an electronic cigarette, wherein the atomizing device includes a first housing, an air duct, an atomizing assembly, a heating assembly, a base, and a first electrode assembly; wherein a first end of the first housing is provided with an air outlet, and a second end of the first housing is open; the atomizing assembly is disposed in the second end of the first housing, and the base is disposed on the second end of the first housing and matched and connected with the atomizing assembly;

the air duct is disposed in the first housing and two ends of the air duct are respectively connected with the air outlet and the atomizing assembly; a space between the first housing and the air duct defines a liquid storage cavity;

the heating assembly is disposed on the atomizing assembly, and an atomizing chamber is defined between the heating assembly and the base; the air inlet, the atomizing chamber, the air duct and the air outlet are communicated to define an airflow passage; the atomizing assembly is provided with a liquid inlet communicating the liquid storage cavity with the heating assembly; and

the first electrode assembly is disposed on the base and is in contact conduction with the heating assembly.

Preferably, the heating assembly includes a liquid transfer body, a heating element disposed on the liquid transfer body, and two conductors respectively disposed at two opposite ends of the heating element;

the first electrode assembly includes a positive electrode and a negative electrode; and the two conductors are respectively in contact conduction with the positive electrode and the negative electrode.

Preferably, the two conductors are respectively provided with leads; the two leads are respectively connected with the positive electrode and the negative electrode for conduction.

Preferably, the positive electrode and the negative electrode are respectively elastic electrodes which are axially retractable; the positive electrode and the negative electrode are respectively in elastic contact with the two conductors for conduction.

Preferably, the atomizing assembly includes an elastic first atomizing seat, a hard second atomizing seat and an elastic third atomizing seat;

the first atomizing seat is sleeved one end of the second atomizing seat and is tightly matched with an inner wall of the first housing; the third atomizing seat is embedded in another end of the second atomizing seat, and the heating assembly is embedded in one side of the third atomizing seat facing to the base; and

the liquid inlet extends through the first atomizing seat to the third atomizing seat.

Preferably, the first atomizing seat is provided with a positioning hole, and one end of the air duct is inserted into the positioning hole; and

the positioning hole is communicated with the air inlet through a gap between the atomizing assembly and an inner wall of the first housing.

Preferably, the atomizing assembly includes a first atomizing seat, a second atomizing seat and a third atomizing seat;

the first atomizing seat is tightly matched with an inner wall of the first housing; the second atomizing seat is embedded in the first atomizing seat and faces the base, and the heating assembly is embedded in one side of the second atomizing seat facing the base; the third atomizing seat is disposed on the base and is connected with the first atomizing seat; the liquid inlet extends through the first atomizing seat to the second atomizing seat; and

the positive electrode and the negative electrode extend into the third atomizing seat respectively; the two conductors are further provided with leads respectively, and the two leads respectively extend into the third atomizing seat and are bent and extended to be attached to surfaces of the positive electrode and the negative electrode for conduction.

Preferably, the atomizing device further includes a sealing ring disposed between the base or the atomizing assembly and the first housing.

Preferably, the atomizing device further includes a suction nozzle disposed on the first end of the first housing, and a suction nozzle cotton disposed between the suction nozzle and an end portion of the first end of the first housing.

The present disclosure further provides an electronic cigarette, including a power supply device and the atomizing device according to any one of the above which are mutually matched and connected.

Preferably, the power supply device comprises a second housing, a battery, a second electrode assembly, a control assembly and a bracket;

the battery is disposed in the second housing, and the second electrode assembly is disposed on the battery and is exposed out of one end of the second housing; the control assembly is disposed at another end of the second housing through the bracket; the bracket is provided with a charging port electrically connected with the control assembly; and

the second electrode assembly is contact conduction with the first electrode assembly of the atomizing device.

According to the present disclosure, the components of the atomizing device are simplified, thus the assembly is simple, the automatic production is facilitated, and the cost is reduced. The atomizing device is connected with the power supply device to form the electronic cigarette, the electrode assemblies of the atomizing device and the power supply device are directly contacted for conduction, without a connecting assembly or the like provided therebetween, so that the whole volume of the electronic cigarette is reduced, and the electronic cigarette is more convenient to carry.

### BRIEF DESCRIPTION OF THE DRAWINGS

The disclosure will be further described with reference to the accompanying drawings and specific embodiments. In the drawings,

FIG. 1 is a sectional view of an atomizing device according to a first embodiment of the present disclosure;

FIG. 2 is an exploded view of the atomizing device according to the first embodiment of the present disclosure;

FIG. 3 is a sectional view of an atomizing device according to a second embodiment of the present disclosure;

FIG. 4 is a sectional view of an atomizing device according to a third embodiment of the present disclosure;

FIG. 5 is a sectional view of an atomizing device according to a fourth embodiment of the present disclosure;

FIG. 6 is an exploded view of the atomizing device according to the fourth embodiment of the present disclosure;

FIG. 7 is a sectional view of an electronic cigarette according to an embodiment of the present disclosure.

### DETAILED DESCRIPTION

To clearly understand the technical features, objectives and effects of the disclosure, the specific embodiments of the disclosure will now be described in detail with reference to the accompanying drawings.

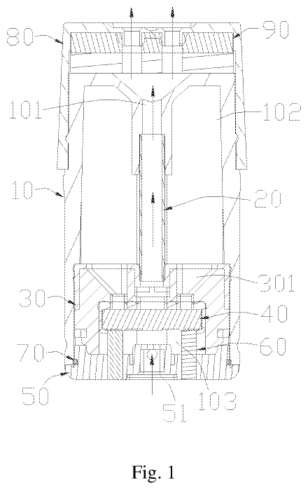

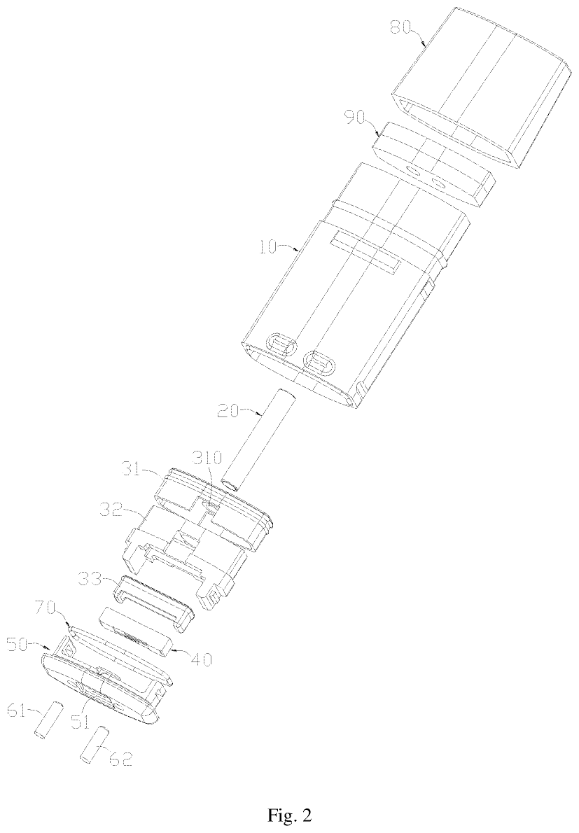

As shown in FIGS. 1 and 2, an atomizing device of an electronic cigarette according to a first embodiment of the present disclosure may include a first housing 10, an air duct 20, an atomizing assembly 30, a heating assembly 40, a base 50, and a first electrode assembly 60.

The first housing 10 is a tubular structure, and includes a first end and a second end opposite to each other. The first end is closed and provided with an air outlet 101, and the second end is open. A liquid storage cavity 102 is defined in the first housing 10 for storing smoke liquid.

The air duct 20 is disposed in the first housing 10, and one end of the air duct 20 is connected to the air outlet 101 in an interference manner or the like and communicates with the air outlet 101. A space between the first housing 10 and the air duct 20 defines the liquid storage cavity 102.

In this embodiment, the air duct 20 is inserted in the center of the first housing 10, and the liquid storage cavity 102 surrounds the air duct 20. In other embodiments, the air duct 20 may be integrally formed in the first housing 10.

The atomizing assembly 30 is disposed in the second end of the first housing 10, so as to seal the second end of the first housing 10, thereby sealing the liquid storage cavity 102. Another end of the air duct 20 is connected to the atomizing assembly 30 in an interference manner, and an internal passage of the air duct 20 is isolated from the liquid storage cavity 102. The heating assembly 40 is disposed on the atomizing assembly 30, and the atomizing assembly 30 is provided with a liquid inlet 301 communicating the liquid storage cavity 102 with the heating assembly 40.

Specifically, the atomizing assembly 30 may include a first atomizing seat 31, a second atomizing seat 32 and a third atomizing seat 33 which are fitted with each other. The first atomizing seat 31 is sleeved on one end of the second atomizing seat 32 and is tightly matched with an inner wall of the first housing 10. A side surface of the first atomizing seat 31 and the inner wall of the first housing 10 can be further tightly fitted by a concavo-convex structure. The first atomizing seat 31 is provided with a positioning hole 310, and one end of the air duct 20 is inserted into the positioning hole 310. The positioning hole 310 can extend through the second atomizing seat 32.

The third atomizing seat 33 is embedded in another end of the second atomizing seat 32, and an outer surface of the second atomizing seat 32 can be further provided with a buckle to be fixed with an inner wall of the first housing 10 in a buckle manner.

The second atomizing seat 32 is the structural main body of the atomizing assembly 20, and is made of hard material such as plastic to maintain the structural strength of the atomizing assembly 30. The first atomizing seat 31 and the third atomizing seat 33 can be made of elastic material with certain sealing performance, which can effectively prevent the smoke liquid from leaking out of the atomizing device during transportation, storage or falling.

The heating assembly 40 is embedded in one side of the third atomizing seat 33 facing the base 50. The liquid inlet 301 extends through the first atomizing seat 31 to the third atomizing seat 33, so that the smoke liquid can flow to the heating assembly 40 via the liquid inlet 301. The heating assembly 40 may include a liquid transfer body, a heating element disposed on the liquid transfer body, and two conductors respectively disposed at two opposite ends of the heating element. The liquid transfer body is used for adsorbing smoke liquid, and the heating element is preferably arranged on one side of the liquid transfer body facing the base 50. The conductor is used to electrically connect with the first electrode assembly 60.

The base 50 is disposed on the second end of the first housing 10 and is engaged with the atomizing assembly 30. A periphery of a bottom of the base 50 may be connected with the open port of the second end of the first housing 10 in a buckle manner through a step. The heating assembly 40 is disposed on the atomizing assembly 30 and faces the base 50, and an atomizing chamber 103 is defined between the heating assembly 40 and the base 50. The base 50 is provided with an air inlet 51. The air inlet 51, the atomizing chamber 103, the air duct 20 and the air outlet 101 are communicated to define an airflow passage, and the airflow flows in an arrow direction as shown in FIG. 1. The smoke liquid in the liquid storage cavity 102 flows to the heating assembly 40 via the liquid inlet 301 to be atomized, and the atomized smoke is output via the airflow passage.

The positioning hole 310 communicates with the air inlet 51 through a gap between the atomizing assembly 30 and an inner wall of the first housing 10, so that the air duct 20 communicates with the atomizing chamber 103 and the air inlet 51 via the positioning hole 310.

The first electrode assembly 60 is disposed on the base 50 and in contact conduction with the heating assembly 40. The first electrode assembly 60 includes a positive electrode 61 and a negative electrode 62. The positive electrode 61 and the negative electrode 62 are in contact electrical connection with the two conductors of the heating assembly 50, respectively.

In this embodiment, the positive electrode 61 and the negative electrode 62 are columns respectively, and are respectively in direct contact with the two conductors of the heating assembly 40. By virtue of the elasticity of the third atomizing seat 33, the pressure applied to the conductors by the first electrode assembly 60 is relatively large, so that the positive electrode 61 and the negative electrode 62 can be in stable contact with the corresponding conductors, thus the electrical connection performance is good.

Further, the atomizing device of this embodiment further includes a sealing ring 70 disposed between the base 50 and the first housing 10 to seal a gap therebetween.

The atomizing device of this embodiment further includes a suction nozzle 80 disposed on the first end of the first housing 10, and a suction nozzle cotton 90 disposed between the suction nozzle 80 and the first end of the first housing 10. Specifically, the suction nozzle 80 is sleeved on the first end of the first housing 10 in a snap-fit manner, and a suction nozzle passage of the suction nozzle 80 is communicated with the air outlet 101 of the first housing 10. The suction nozzle cotton 90 is disposed between the suction nozzle 80 and an end portion of the first end of the first housing 10, and is used for absorbing condensed smoke liquid to prevent the smoke liquid from entering the user's mouth during suction.

When assembling the atomizing device of the embodiment, the air duct 20, the atomizing assembly 30, the heating assembly 40 and the base 50 are sequentially assembled into the first housing 10 in a same direction, so that the operation is simple, and automatic production is facilitated.

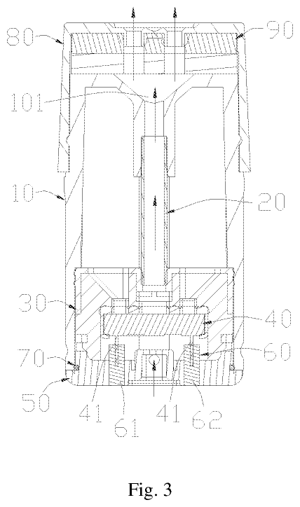

As shown in FIG. 3, an atomizing device of an electronic cigarette according to a second embodiment of the present disclosure may include a first housing 10, an air duct 20, an atomizing assembly 30, a heating assembly 40, a base 50, and a first electrode assembly 60.

The arrangement of the first housing 10, the air duct 20, the atomizing assembly 30, the heating assembly 40, the base 50, and the first electrode assembly 60 may be as described above with reference to the first embodiment, and will not be repeated herein.

The difference between this embodiment and the first embodiment is that the two conductors of the heating assembly 40 are respectively provided with leads 41.

The two leads 41 are electrically connected to the positive electrode 61 and the negative electrode 62 of the first electrode assembly 60, respectively. The lead 41 may be connected with the positive electrode 61/negative electrode 62 by welding, riveting, or the like, so that the contact connection between the heating assembly 40 and the first electrode assembly 60 is more stable.

Further, the atomizing device of this embodiment further includes a sealing ring 70 disposed between the base 50 and the first housing 10 to seal a gap therebetween.

The atomizing device of this embodiment further includes a suction nozzle 80 disposed on the first end of the first housing 10, and a suction nozzle cotton 90 disposed between the suction nozzle 80 and the first end of the first housing 10. Specifically, the suction nozzle 80 is sleeved on the first end of the first housing 10 in a snap-fit manner, and a suction nozzle passage of the suction nozzle 80 is communicated with the air outlet 101 of the first housing 10. The suction nozzle cotton 90 is disposed between the suction nozzle 80 and an end portion of the first end of the first housing 10, and is used for absorbing condensed smoke liquid to prevent the smoke liquid from entering the user's mouth during suction.

When assembling the atomizing device of the embodiment, the air duct 20, the atomizing assembly 30, the heating assembly 40 and the base 50 are sequentially assembled into the first housing 10 in a same direction, so that the operation is simple, and automatic production is facilitated.

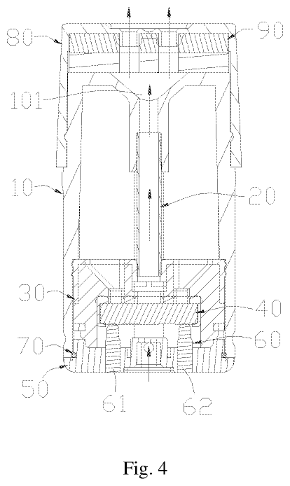

As shown in FIG. 4, an atomizing device of an electronic cigarette according to a third embodiment of the present disclosure may include a first housing 10, an air duct 20, an atomizing assembly 30, a heating assembly 40, a base 50, and a first electrode assembly 60.

The arrangement of the first housing 10, the air duct 20, the atomizing assembly 30, the heating assembly 40, the base 50, and the first electrode assembly 60 may be as described above with reference to the first embodiment, and will not be repeated herein.

The difference between this embodiment and the first embodiment is that the positive electrode 61 and the negative electrode 62 of the first electrode assembly 60 are respectively elastic electrodes which are axially retractable. The positive electrode 61 and the negative electrode 62 are elastically contacted with the two conductors of the heating assembly 40 respectively, so that the contact is stable and maintenance is facilitated.

Further, the atomizing device of this embodiment further includes a sealing ring 70 disposed between the base 50 and the first housing 10 to seal a gap therebetween.

The atomizing device of this embodiment further includes a suction nozzle 80 disposed on the first end of the first housing 10, and a suction nozzle cotton 90 disposed between the suction nozzle 80 and the first end of the first housing 10. Specifically, the suction nozzle 80 is sleeved on the first end of the first housing 10 in a snap-fit manner, and a suction nozzle passage of the suction nozzle 80 is communicated with the air outlet 101 of the first housing 10. The suction nozzle cotton 90 is disposed between the suction nozzle 80 and an end portion of the first end of the first housing 10, and is used for absorbing condensed smoke liquid to prevent the smoke liquid from entering the user's mouth during suction.

When assembling the atomizing device of the embodiment, the air duct 20, the atomizing assembly 30, the heating assembly 40 and the base 50 are sequentially assembled into the first housing 10 in a same direction, so that the operation is simple, and automatic production is facilitated.

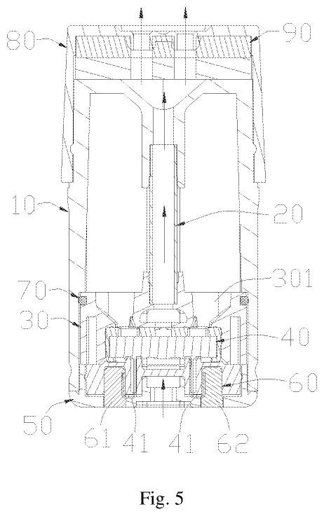

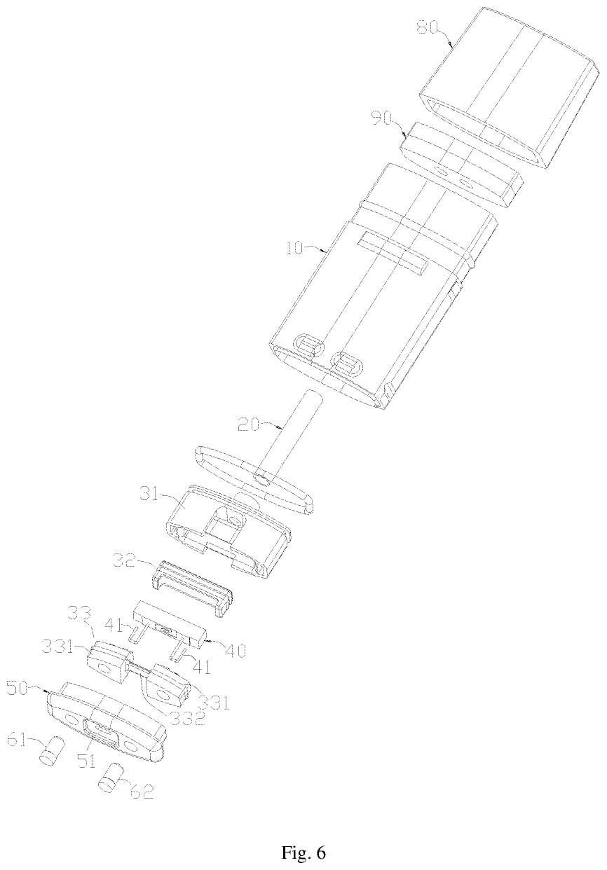

As shown in FIGS. 5 and 6, an atomizing device of an electronic cigarette according to a fourth embodiment of the present disclosure may include a first housing 10, an air duct 20, an atomizing assembly 30, a heating assembly 40, a base 50, and a first electrode assembly 60. And the atomizing device may further include a sealing ring 70, a suction nozzle 80, and a suction nozzle cotton 90.

The arrangement of the first housing 10, the air duct 20, the atomizing assembly 30, the heating assembly 40, the base 50, the first electrode assembly 60, the suction nozzle 80 and the suction nozzle cotton 90 may be as described with reference to the above first embodiment.

The atomizing assembly 30 includes a first atomizing seat 31, a second atomizing seat 32, and a third atomizing seat 33. The difference between this embodiment and the first embodiment is that the first atomizing seat 31 is tightly fitted with an inner wall of the first housing 10; the second atomizing seat 32 is embedded in the first atomizing seat 31 and faces the base 50, and the heating assembly 40 is embedded in one side of the second atomizing seat 32 facing the base 50; the third atomizing seat 33 is disposed on the base 50 and connected to the first atomizing seat 31. The liquid inlet 301 extends through the first atomizing seat 31 to the second atomizing seat 32.

The first atomizing seat 31 is the structural main body of the atomizing assembly 20, and is made of hard material such as plastic to maintain the structural strength of the atomizing assembly 30. The second atomizing seat 32 and the third atomizing seat 33 can be made of elastic material with certain sealing performance, which can effectively prevent the smoke liquid from leaking to the outside of the atomizing device during transportation, storage or falling.

The positive electrode 61 and the negative electrode 62 of the first electrode assembly 60 are columnar respectively, and are disposed on the base 50, and extend into the third atomizing seat 33 respectively.

Further, the two conductors of the heating assembly 40 are respectively provided with leads 41. The two leads 41 respectively extend into the third atomizing seat 33, and are respectively bent and extended to be tightly attached to surfaces of the positive electrode 61 and the negative electrode 62 for conduction. In this embodiment, a bent portion of the lead 41 extending into the third atomizing seat 33 and bent and extended can be tightly attached to an axial surface of the positive electrode 61/negative electrode 62, and the lead 41 and the positive electrode 61/negative electrode 62 are positioned by extending into the third atomizing seat 33, so that the lead 41 and the positive electrode 61/negative electrode 62 can be stably contacted to conduct.

The arrangement of the third atomizing seat 33 on the base 50 can effectively prevent the smoke liquid from leaking to the air inlet 51 of the base 50.

Specifically, in this embodiment, the air inlet 51 is located in the center of the base 50. The third atomizing seat 33 includes two seats 331 which are spaced disposed on two opposite sides of the air inlet 51, and the two seats 331 are connected through a connecting rod 332 to form the third atomizing seat 33 integrally. The connecting rod 332 is slender relative to the base 331, and thus does not affect the communication between the air inlet 51 and the air duct 20.

The base 331 is provided with through holes for the positive electrode 61/the negative electrode 62 and the lead 41 to pass through.

The seal ring 70 is disposed between the first housing 10 and the atomizing assembly 30 (the first atomizing seat 31), and has the function of sealing and fastening.

When assembling the atomizing device of the embodiment, the air duct 20, the atomizing assembly 30, the heating assembly 40 and the base 50 are sequentially assembled into the first housing 10 in a same direction, so that the operation is simple, and automatic production is facilitated.

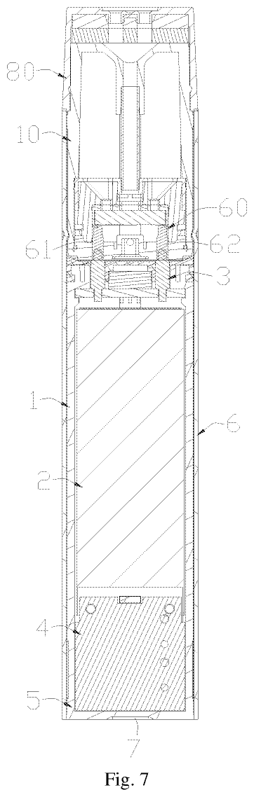

As shown in FIG. 7, an electronic cigarette according to an embodiment of the present disclosure includes a power supply device and an atomizing device which are mutually matched and connected. The atomizing device is the atomizing device of any one of the above embodiments.

The power supply device may include a second housing 1, a battery 2, a second electrode assembly 3, a control assembly 4, and a bracket 5. The battery 2 is disposed in the second housing 1, and the second electrode assembly 3 is disposed on the battery 2 and exposed out of one end of the second housing 1. The control assembly 4 is disposed at another end of the second housing 1 through the bracket 5. The bracket 5 is provided with a charging port 7 electrically connected with the control assembly 4, so that the battery 2 can be charged by an external power supply.

The atomizing device and the power supply device are connected by a buckle or a magnetic attraction mode, which is more convenient and faster than a thread connection.

One end of the power supply device exposing the second electrode assembly 3 is connected with the atomizing device in a matching way, wherein the second housing 1 is connected with the first housing 10 of the atomizing device, and a gap is defined between the second housing 1 and the first housing 10 for air to enter into the atomizing device. The second electrode assembly 3 is in contact conduction with the first electrode assembly 60, and a connecting assembly or the like is not required to be provided therebetween. The second electrode assembly 3 also includes a positive electrode and a negative electrode respectively in contact conduction with the positive electrode 61 and the negative electrode 62 of the first electrode assembly 60.

The positive electrode and the negative electrode of the second electrode assembly 3 may be respectively elastic electrodes which are axially retractable, and elastically contact with the positive electrode 61 and the negative electrode 62 of the first electrode assembly 60 to conduct, so that the contact is stable.

Further, the electronic cigarette of the present disclosure may further include a third housing 6 corresponding to the power supply device and the atomizing device. The third housing 6 is disposed outside the first housing 10 and the second housing 1, and one end surface of the third housing 6 is connected with the suction nozzle 80 of the atomizing device, so that the atomizing device and the power supply device are received in the third housing 6, to form the electronic cigarette with an integral appearance.

It should be understandable that the above embodiments are only preferred embodiments of the disclosure, and the description thereof is more specific and detailed, but it is not to be construed as limiting the scope of the patent of the disclosure. It should be noted that a person skilled in the art can freely combine the foregoing technical features and also can make several modifications and improvements without departing from the concept of the disclosure, and these modifications and improvements are all within the scope of protection of the present disclosure. Therefore, all equivalent transformations and modifications made according to the scope of the claims of the disclosure shall fall within the scope of the claims of the disclosure.

What is claimed is:

1. An atomizing device for an electronic cigarette, wherein the atomizing device comprises a first housing, an air duct, an atomizing assembly, a heating assembly, a base, and a first electrode assembly; a first end of the first housing is provided with an air outlet, and a second end of the first housing is open; the atomizing assembly is disposed in the second end of the first housing, and the base is disposed on the second end of the first housing and matched and connected with the atomizing assembly;
the air duct is disposed in the first housing and two ends of the air duct are respectively connected with the air outlet and the atomizing assembly; a space between the first housing and the air duct defines a liquid storage cavity;
the heating assembly is disposed on the atomizing assembly, and an atomizing chamber is defined between the heating assembly and the base; the air inlet, the atomizing chamber, the air duct and the air outlet are communicated to define an airflow passage; the atomizing assembly is provided with a liquid inlet communicating the liquid storage cavity with the heating assembly; and
the first electrode assembly is disposed on the base and is in contact conduction with the heating assembly.

2. The atomizing device according to claim 1, wherein the heating assembly comprises a liquid transfer body, a heating element disposed on the liquid transfer body, and two conductors respectively disposed at two opposite ends of the heating element; and
the first electrode assembly includes a positive electrode and a negative electrode; and the two conductors are respectively in contact conduction with the positive electrode and the negative electrode.

3. The atomizing device according to claim 2, wherein the two conductors are respectively provided with leads; the two leads are respectively connected with the positive electrode and the negative electrode for conduction.

4. The atomizing device according to claim 2, wherein the positive electrode and the negative electrode are respectively elastic electrodes which are axially retractable; the positive electrode and the negative electrode are respectively in elastic contact with the two conductors for conduction.

5. The atomizing device according to claim 2, wherein the atomizing assembly comprises an elastic first atomizing seat, a hard second atomizing seat and an elastic third atomizing seat;
the first atomizing seat is sleeved one end of the second atomizing seat and is tightly matched with an inner wall of the first housing; the third atomizing seat is embedded in another end of the second atomizing seat, and the heating assembly is embedded in one side of the third atomizing seat facing to the base; and
the liquid inlet extends through the first atomizing seat to the third atomizing seat.

6. The atomizing device according to claim 5, wherein the first atomizing seat is provided with a positioning hole, and one end of the air duct is inserted into the positioning hole; and
the positioning hole is communicated with the air inlet through a gap between the atomizing assembly and an inner wall of the first housing.

7. The atomizing device according to claim 2, wherein the atomizing assembly comprises a first atomizing seat, a second atomizing seat and a third atomizing seat;
the first atomizing seat is tightly matched with an inner wall of the first housing; the second atomizing seat is embedded in the first atomizing seat and faces the base, and the heating assembly is embedded in one side of the second atomizing seat facing the base; the third atomizing seat is disposed on the base and is connected with the first atomizing seat; the liquid inlet extends through the first atomizing seat to the second atomizing seat;
the positive electrode and the negative electrode extend into the third atomizing seat respectively; the two conductors are further provided with leads respectively, and the two leads respectively extend into the third atomizing seat and are bent and extended to be attached to surfaces of the positive electrode and the negative electrode for conduction.

8. The atomizing device according to claim 1, further comprising a sealing ring disposed between the base or the atomizing assembly and the first housing.

9. The atomizing device according to claim 1, further comprising a suction nozzle disposed on the first end of the first housing, and a suction nozzle cotton disposed between the suction nozzle and an end portion of the first end of the first housing.

10. An electronic cigarette, comprising a power supply device and an atomizing device which are mutually matched and connected; wherein,
the atomizing device comprises a first housing, an air duct, an atomizing assembly, a heating assembly, a base, and a first electrode assembly; a first end of the first housing is provided with an air outlet, and a second end of the first housing is open; the atomizing assembly is disposed in the second end of the first housing, and the base is disposed on the second end of the first housing and matched and connected with the atomizing assembly;
the air duct is disposed in the first housing and two ends of the air duct are respectively connected with the air outlet and the atomizing assembly; a space between the first housing and the air duct defines a liquid storage cavity;
the heating assembly is disposed on the atomizing assembly, and an atomizing chamber is defined between the heating assembly and the base; the air inlet, the atomizing chamber, the air duct and the air outlet are communicated to define an airflow passage; the atomizing assembly is provided with a liquid inlet communicating the liquid storage cavity with the heating assembly; and
the first electrode assembly is disposed on the base and is in contact conduction with the heating assembly.

11. The electronic cigarette according to claim 10, wherein the power supply device comprises a second housing, a battery, a second electrode assembly, a control assembly and a bracket;
the battery is disposed in the second housing, and the second electrode assembly is disposed on the battery and is exposed out of one end of the second housing; the control assembly is disposed at another end of the second housing through the bracket; the bracket is provided with a charging port electrically connected with the control assembly; and
the second electrode assembly is contact conduction with the first electrode assembly of the atomizing device.

12. The electronic cigarette according to claim 10, wherein the heating assembly comprises a liquid transfer body, a heating element disposed on the liquid transfer body, and two conductors respectively disposed at two opposite ends of the heating element; and
the first electrode assembly includes a positive electrode and a negative electrode; and the two conductors are respectively in contact conduction with the positive electrode and the negative electrode.

13. The electronic cigarette according to claim 12, wherein the two conductors are respectively provided with leads; the two leads are respectively connected with the positive electrode and the negative electrode for conduction.

14. The electronic cigarette according to claim 12, wherein the positive electrode and the negative electrode are respectively elastic electrodes which are axially retractable; the positive electrode and the negative electrode are respectively in elastic contact with the two conductors for conduction.

15. The electronic cigarette according to claim 12, wherein the atomizing assembly comprises an elastic first atomizing seat, a hard second atomizing seat and an elastic third atomizing seat;
the first atomizing seat is sleeved one end of the second atomizing seat and is tightly matched with an inner wall of the first housing; the third atomizing seat is embedded in another end of the second atomizing seat, and the heating assembly is embedded in one side of the third atomizing seat facing to the base; and
the liquid inlet extends through the first atomizing seat to the third atomizing seat.

16. The electronic cigarette according to claim 15, wherein the first atomizing seat is provided with a positioning hole, and one end of the air duct is inserted into the positioning hole; and
the positioning hole is communicated with the air inlet through a gap between the atomizing assembly and an inner wall of the first housing.

17. The electronic cigarette according to claim 12, wherein the atomizing assembly comprises a first atomizing seat, a second atomizing seat and a third atomizing seat;
the first atomizing seat is tightly matched with an inner wall of the first housing; the second atomizing seat is embedded in the first atomizing seat and faces the base, and the heating assembly is embedded in one side of the second atomizing seat facing the base; the third atomizing seat is disposed on the base and is connected with the first atomizing seat; the liquid inlet extends through the first atomizing seat to the second atomizing seat;
the positive electrode and the negative electrode extend into the third atomizing seat respectively; the two conductors are further provided with leads respectively, and the two leads respectively extend into the third atomizing seat and are bent and extended to be attached to surfaces of the positive electrode and the negative electrode for conduction.

18. The electronic cigarette according to claim 10, further comprising a sealing ring disposed between the base or the atomizing assembly and the first housing.

19. The electronic cigarette according to claim 10, further comprising a suction nozzle disposed on the first end of the first housing, and a suction nozzle cotton disposed between the suction nozzle and an end portion of the first end of the first housing.
